(19) United States
(12) Patent Application Publication
(10) Pub. No.: US 2015/0123846 A1
(43) Pub. Date: May 7, 2015

(54) APPARATUS AND METHOD FOR DETECTING DECEPTION SIGNAL IN GLOBAL NAVIGATION SATELLITE RECEIVER

(71) Applicant: Electronics and Telecommunications Research Institute, Daejeon (KR)

(72) Inventors: Seong Kyun JEONG, Suwon-si (KR); Sang Uk LEE, Daejeon (KR); Jae Hoon KIM, Daejeon (KR)

(73) Assignee: Electronics and Telecommunications Research Institute, Daejeon (KR)

(21) Appl. No.: 14/336,273

(22) Filed: Jul. 21, 2014

(30) Foreign Application Priority Data
Nov. 4, 2013 (KR) 10-2013-0133148

(51) Int. Cl. G01S 19/21

(52) U.S. Cl. CPC G01S 19/215
USPC 342/357.59

(57) ABSTRACT

An apparatus and method for detecting a deception signal in a global navigation satellite receiver is disclosed, the apparatus for detecting the deception signal in the global navigation satellite receiver including an identifier to identify output data output from a global navigation satellite receiver receiving an input of a global navigation satellite signal, and a determiner to determine whether the global navigation satellite signal is a deception signal and a normal signal.

### CROSS-REFERENCE TO RELATED APPLICATION

This application claims the priority benefit of Korean Patent Application No. 10-2013-0133148, filed on Nov. 4, 2013, in the Korean Intellectual Property Office, the disclosure of which is incorporated herein by reference.

### BACKGROUND

1. Field of the Invention

The present invention relates to a method of detecting an anomaly with respect to a global navigation satellite signal by detecting a deception signal based on output data of a global navigation satellite receiver.

2. Description of the Related Art

A global positioning system (GPS) refers to a system for providing a global service of indicating a position, an altitude, and a speed of a moving object to which a global navigation satellite receiver is attached, using a navigation satellite. In general, an excess of four navigation satellites are within a viewing range of an antenna, and a user may obtain position information and time information of the user through use of the global navigation satellite receiver. Due to an advantage of providing a global navigation satellite service using the global navigation satellite receiver, the GPS is utilized in various fields, for example, navigation, transportation, a location-based service, time synchronization, and military affairs.

With a widespread use of the GPS, a great deal of havoc is anticipated when disturbances occur in the GPS. A global navigation satellite signal may be vulnerable to a jamming radio wave due to a weak terrestrial signal power. Accordingly, providing an accurate global navigation satellite service may be difficult depending on surrounding conditions because the global navigation satellite signal is prone to an occurrence of purposeful disturbances, in addition to those without deliberate intent.

Disturbances with respect to the GPS may be generated by a jamming signal or a deception signal. For example, when a relatively greater signal power, or a jamming signal, is transmitted to a frequency bandwidth of the GPS, a disturbance in which the global navigation satellite receiver is unable to receive a global navigation satellite signal may occur. Alternatively, when a deception signal copying the global navigation satellite signal is admitted to the global navigation satellite receiver, several application fields based on navigation solution data may be afflicted with heavy damage because the global navigation satellite receiver continuously generates the navigation solution data with respect to an erroneous position and a time.

Conventionally, various examination methods of detecting a deception attack directed towards the GPS have been suggested, for example, detecting a deception signal by monitoring measurement data, a navigation message, or a signal intensity change. However, distinguishing between a disturbance caused by the deception signal, also referred to as a deception attack, and a momentary anomaly of the global navigation satellite signal is difficult because each of the examination methods is conducted single-handedly. Moreover, a difficulty exists in precisely verifying a deception attack when the deception attack is comprehensively inflicted, or when a degree of position change in the global navigation satellite receiver caused by the deception attack is nominal.

Accordingly, there is a need for a technology for overcoming the aforementioned issues and enhancing a performance in detecting a deception signal.

### SUMMARY

According to an aspect of the present invention, there is provided an apparatus for detecting a deception signal in a global navigation satellite receiver, the apparatus including an identifier configured to identify data output from a global navigation satellite receiver receiving an input of a global navigation satellite signal, and a determiner configured to determine whether the global navigation satellite signal is a deception signal or a normal signal based on the output data.

According to an aspect of the present invention, there is provided a method of detecting a deception signal in a global navigation satellite receiver, the method including identifying data output from a global navigation satellite receiver receiving an input of a global navigation satellite signal, and determining whether the global navigation satellite signal is a deception signal or a normal signal using the output data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an internal configuration of an apparatus for detecting a deception signal in a global navigation satellite receiver according to an embodiment of the present invention;

FIG. 2 is a diagram illustrating an internal configuration of a determiner according to an embodiment of the present invention;

FIG. 3 is a flowchart illustrating a method of detecting a deception signal in a global navigation satellite receiver according to an embodiment of the present invention;

FIG. 4 is a flowchart illustrating a method of detecting a deception signal in a global navigation satellite receiver according to another embodiment of the present invention; and

FIG. 5 is a flowchart illustrating an operation process of an examiner according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

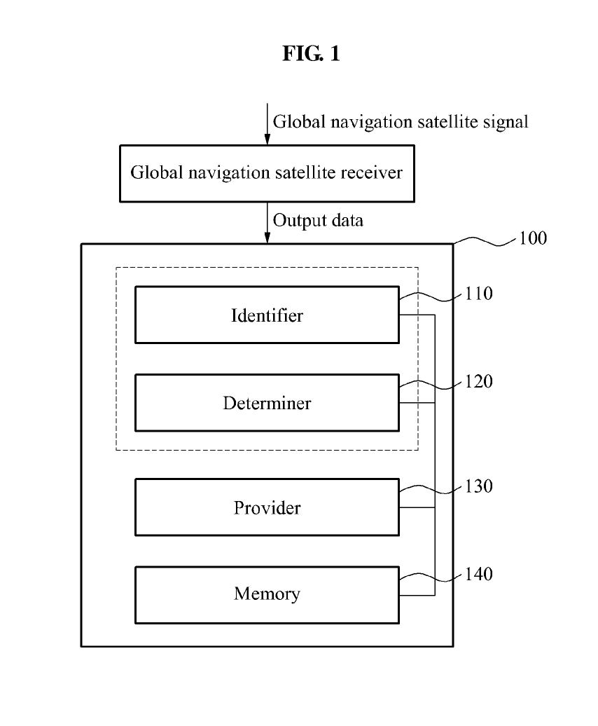

FIG. 1 is a diagram illustrating an internal configuration of an apparatus 100 for detecting a deception signal in a global navigation satellite receiver according to an embodiment of the present invention.

Referring to FIG. 1, the apparatus 100 for detecting the deception signal includes an identifier 110 and a determiner 120. The apparatus 100 for detecting the deception signal further includes a provider 130 and a memory 140.

The identifier 110 may identify output data output from a global navigation satellite receiver receiving an input of a global navigation satellite signal.

The global navigation satellite receiver may receive, through a global navigation satellite antenna, an input of a global navigation satellite signal transmitted from a navigation satellite.

The global navigation satellite receiver may generate navigation solution data with respect to a position and a time of the global navigation satellite receiver based on the global navigation satellite signal input.

When an apparatus for deceiving a global navigation satellite (not shown) disguises a deception signal as the global navigation satellite signal and transmits the disguised deception signal to the global navigation satellite receiver, the global navigation satellite receiver may generate navigation solution data including a disturbed position and time intended by the apparatus for deceiving the global navigation satellite.

The global navigation satellite receiver may output measurement data associated with a pseudo range between a navigation satellite and the global navigation satellite receiver and a carrier phase.

The global navigation satellite receiver may output a navigation message including data associated with a satellite orbit or a satellite clock error correction parameter received from the navigation satellite.

The global navigation satellite receiver may output a signal intensity of the global navigation satellite signal.

The identifier 110 may identify, as the output data, at least one item of information about the measurement data, the navigation message, the navigation solution data, and the signal intensity of the global navigation satellite signal.

The determiner 120 may determine whether the global navigation satellite signal is a deception signal or a normal signal based on the output data.

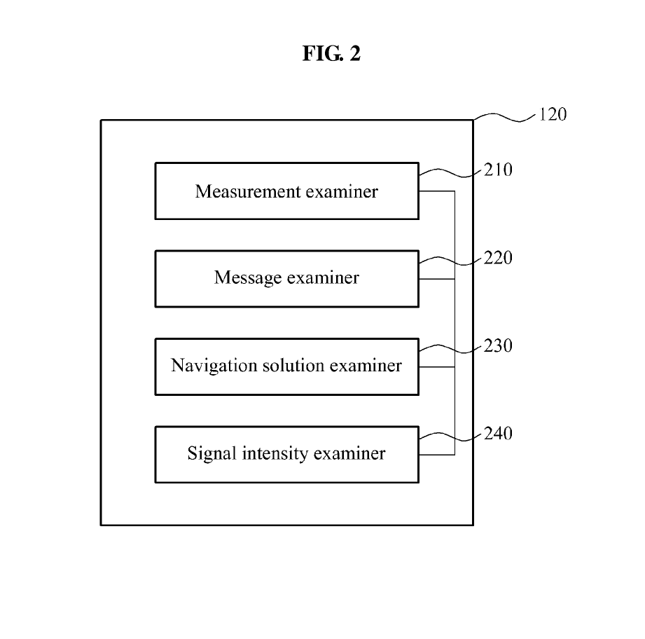

Hereinafter, the determiner 120 will be described with reference to FIG. 2.

FIG. 2 is a diagram illustrating an internal configuration of a determiner 120 according to an embodiment of the present invention.

Referring to FIG. 2, the determiner 120 includes a measurement examiner 210, a message examiner 220, a navigation solution examiner 230, and a signal intensity examiner 240.

The measurement examiner 210 may generate a first value for examination by comparing the pseudo range and the carrier phase within the measurement data to a normal value, and when the first value for examination exceeds a predetermined value, detect an anomaly with respect to the measurement data, and determine the global navigation satellite signal to be a deception signal.

The normal value may be read from the memory 140 as measurement data including a pseudo range and a carrier phase in a most recent instance during which the first value for examination is determined to be normal. Alternatively, the normal value may be input by a user.

For example, the measurement examiner 210 may generate a difference between the pseudo range and the carrier phase within the measurement data, and the normal value as the first value for examination. The measurement examiner 210 may determine the first value for examination to be normal when the first value for examination is less than a predetermined value, and when the first value for examination exceeds the predetermined value, detect an anomaly with respect to the pseudo range and the carrier phase within the measurement data caused by a deception signal.

The message examiner 220 may generate a second value for examination by comparing the navigation message to a previous navigation message, and when the second value for examination exceeds a predetermined value, detect an anomaly with respect to the navigation message, and determine the global navigation satellite signal to be a deception signal.

The message examiner 220 may read a previous navigation message maintained in the memory 140, for example, a navigation message in a most recent instance during which the second value for examination is determined to be normal, and generate a difference between the previous navigation message and the satellite orbit or the satellite clock error correction parameter received from the navigation satellite within the navigation message to be the second value for examination. The message examiner 220 may determine the second value for examination to be normal when the second value for examination is less than a predetermined value, and when the second value for examination exceeds the predetermined value, detect an anomaly with respect to the satellite orbit or the satellite clock error correction parameter within the navigation message caused by a deception signal.

When a distance between a position of a fixed point at which the global navigation satellite receiver is disposed and a position of the global navigation satellite receiver exceeds a variable threshold value, the navigation solution examiner 230 may detect an anomaly with respect to the navigation solution data, and determine the global navigation satellite signal to be a deception signal.

For example, the navigation solution examiner 230 may examine whether a position coordinate of the fixed point at which the global navigation satellite receiver is disposed is identical to a position coordinate within the navigation solution data generated by the global navigation satellite receiver. The navigation solution examiner 230 may determine a difference between the two position coordinates to be normal when the difference is less than the variable threshold value, and when the difference exceeds the variable threshold value, detect an anomaly with respect to the position coordinate within the navigation solution data caused by a deception signal.

The variable threshold value may be set using the first value for examination generated by a comparison based on a pseudo range and a carrier phase within measurement data or a second value for examination generated by a comparison based on a navigation message.

For example, when the measurement examiner 210 detects the anomaly with respect to the measurement data due to the first value for examination exceeding the predetermined value, the variable threshold value may be set to be, at a predetermined rate of the first value for examination, for example, 50%, 100%, and 200%, and the navigation solution examiner 230 may detect the anomaly with respect to the navigation solution data using the variable threshold value.

Alternatively, when the message examiner 220 detects the anomaly with respect to the navigation message due to the second value for examination exceeding a predetermined value, the variable threshold value may be set to a predetermined rate of the second value for examination, and the navigation solution examiner 230 may determine the anomaly with respect to the navigation solution data using the variable threshold value.

Hereinafter, equations land 2 to which the threshold value THₚₒₛ of the navigation solution examiner 230 is applied to the first value for examination IDₘₑₐ of the measurement examiner 210 or the second value for examination IDₘₑₛ of the message examiner 220 are represented. Here, cₘₑₐ and cₘₑₛ are adjustment constants.

TH=c·IDₘₑₐ [Equation 1]

TH=cₘₑₛ·IDₘₑₐ [Equation 2]

In general, a position of a global navigation satellite receiver in the navigation message includes usual error components of an ionospheric delay, a tropospheric delay, a satellite orbit error, and a satellite clock error caused by various factors. Conventionally, an anomaly with respect to the navigation solution data is detected using a relatively high fixed threshold value in order to distinguish the usual error components from error components caused by a deception signal, however, when a deception signal intent on causing a relatively small error is admitted, distinguishing whether the small error is caused by a deception signal or a normal signal is difficult.

Accordingly, the navigation solution examiner 230 may readily detect the deception signal causing the relatively small error by variably adjusting the threshold value of the navigation solution examiner 230 based on a plurality of values for examination in the measurement examiner 210 and the message examiner 220.

An apparatus for deceiving a global navigation satellite may transmit a higher deception signal than a normal global navigation satellite signal to the global navigation satellite receiver to allow the global navigation satellite receiver to process the deception signal. Accordingly, the signal intensity examiner 240 may determine the global navigation satellite signal measured to be higher than the normal signal to be the deception signal.

An intensity of the global navigation satellite signal may vary based on an altitude angle of a navigation satellite. When the navigation satellite rises above a horizon and enters a viewing area, a signal intensity may be low, and when the navigation satellite enters the viewing area and the altitude angle of the navigation satellite continues to increase, the signal intensity may be stronger. Accordingly, when an angle of inclination of the navigation satellite is low, determining a presence of a deception signal is difficult based on an absolute value of a signal intensity of the global navigation satellite signal, and various conditions may not be reflected simply by applying an additional threshold value based on the angle of inclination of the navigation satellite.

Through this, the signal intensity examiner 240 may generate a third value for examination by comparing a signal intensity of the global navigation satellite signal subsequent to a predetermined period of time elapsing to a signal intensity reference value, determine whether the third value for examination exceeds a predetermined value, and determine the global navigation satellite signal to be a deception signal.

The signal intensity reference value may be set to be an average intensity value of a “k” number of signals, “k” being a natural number, output from the global navigation satellite receiver.

The signal intensity examiner 240 may measure a current signal intensity of the global navigation satellite signal input to the global navigation receiver to verify a signal intensity change and determine whether the global navigation satellite signal is a deception signal. Also, the signal intensity examiner 240 may verify a signal intensity change subsequent to a predetermined delay time (t) and determine whether the global navigation satellite signal is a deception signal in order to avoid an instance in which a simple signal intensity change is determined to be caused by a deception signal.

Hereinafter, equations 3 and 4 in which the signal intensity reference value (SP) and the third value for examination ID_{sig} in the signal intensity examiner 240 are calculated are represented. The signal intensity reference value (SP) may be set to be an average intensity value of a “k” number of signals, “k” being a natural number from a collection start time (p). The third value for examination ID_{sig} may be generated by a difference between a signal intensity subsequent to the delay time (t) and the signal intensity reference value (SP). The signal intensity examiner 240 may determine the global navigation satellite signal to be a deception signal when the third value for examination exceeds a predetermined value.

$$\begin{matrix}SP = \frac{{\sum }_{n = p}^{p + k - 1} C / {N}_{0} ( n )}{k} & [ Equation 3 ] \\ {ID}_{sig} = C / {N}_{0} ( p + k - 1 + t ) - SP & [ Equation 4 ]\end{matrix}$$

The signal intensity examiner 240 may enhance an accuracy of detecting a deception signal by comparing the signal intensity changes using the delay time (t) value.

The determiner 120 may determine the global navigation satellite signal to be a deception signal concurrently with an anomaly being detected by at least two of the measurement examiner 210, the message examiner 220, and the navigation solution examiner 230.

For one example, with an anomaly being detected by at least two of the measurement examiner 210, the message examiner 220, and the navigation solution examiner 230, when the signal intensity examiner 240 measures an intensity of the global navigation satellite signal to be higher than an intensity of a predetermined normal signal, the signal intensity examiner 240 may determine the global navigation satellite signal to be a deception signal, and otherwise, may determine the global navigation satellite signal to be a normal signal.

When an anomaly is simultaneously detected from the measurement examiner 210 and the navigation solution examiner 230, and the signal intensity examiner 240 measures the intensity of the global navigation satellite signal to be higher than the intensity of the predetermined normal signal, the determiner 120 may determine the global navigation satellite signal to be a deception signal.

When an anomaly is simultaneously detected from the message examiner 220 and the navigation solution examiner 230, and the signal intensity examiner 240 measures the intensity of the global navigation satellite signal to be higher than the intensity of the predetermined normal signal, the determiner 120 may determine the global navigation satellite signal to be a deception signal.

When an anomaly is simultaneously detected from the measurement examiner 210 and the navigation solution examiner 220, and the signal intensity examiner 240 measures the intensity of the global navigation satellite signal to be higher than the intensity of the predetermined normal signal, the determiner 120 may determine the global navigation satellite signal to be a deception signal. As an anomaly is detected from the measurement examiner 210 and the message examiner 220, the determiner 120 may enhance an accuracy of detecting a deception signal in consideration of an instance in which the navigation solution examiner 230 is not affected.

A momentary anomaly is likely to be generated in the output data because the GPS performs positioning using a global navigation satellite signal from a navigation satellite. Accordingly, performing a complex determining as to whether the anomaly is detected simultaneously from the output data is required for an accurate verification of a presence of a deception signal.

Accordingly, as an anomaly is detected by at least two of the measurement examiner 210, the message examiner 220, and the navigation solution examiner 230, an accuracy of detecting a deception signal may be enhanced based on a method of complex determining in which a global navigation satellite signal is determined to be the deception signal.

Referring to FIG. 1, according to the present exemplary embodiment, the apparatus 100 for detecting the deception signal further includes the memory 140.

The memory 140 may maintain a result of the determining by the determiner 120 by associating the result with the output data. For example, the memory 140 may maintain output data processed when the global navigation satellite signal is determined to be the deception signal, and use the processed output data for subsequent detection of a deception signal. The memory 140 may maintain the processed output data by associating the data with a normal signal when the global navigation satellite signal is determined to be a normal signal.

According to the present exemplary embodiment, the apparatus 100 for detecting the to deception signal further includes the provider 130.

The provider 130 may indicate the global navigation satellite signal to be a deception signal when the global navigation satellite signal is determined to be a deception signal. The provider 130 may provide a user with information about a presence of a detected deception signal, and thus readily provide information about authenticity of a global navigation satellite service.

According to the present exemplary embodiment, a presence of an anomaly detected in the global navigation satellite service may be easily verified by determining whether a global navigation satellite signal input to the global navigation satellite receiver is a deception signal or a normal signal based on the output data output from the global navigation satellite receiver.

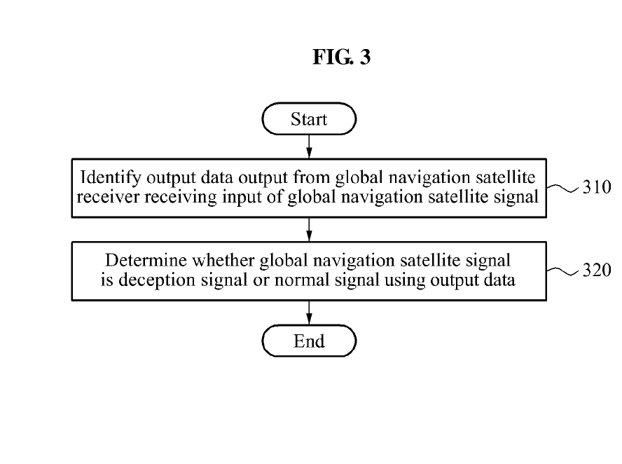

Hereinafter, descriptions pertaining to an operation of the apparatus 100 for detecting the deception signal will be discussed with reference to FIGS. 3 through 5.

FIG. 3 is a flowchart illustrating a method of detecting a deception signal in a global navigation satellite receiver according to an embodiment of the present invention.

The method of detecting the deception signal in the global navigation satellite receiver according to an aspect of the present invention may be performed by the aforementioned apparatus 100 of FIG. 1 for detecting the deception signal.

Referring to FIG. 3, in operation 310, the apparatus 100 for detecting the deception signal may identify output data output from the global navigation satellite receiver receiving an input of a global navigation satellite signal.

The global navigation satellite receiver may receive, through a global navigation satellite antenna, the input of the global navigation satellite signal transmitted from a navigation satellite.

The global navigation satellite receiver may generate navigation solution data associated with a position and a time of the global navigation satellite receiver using the to global navigation satellite signal input.

When an apparatus for deceiving a global navigation satellite (not shown) disguises a deception signal as the global navigation satellite signal and transmits the disguised deception signal to the global navigation satellite receiver, the global navigation satellite receiver may generate navigation solution data including a disturbed position and time as intended by the apparatus for deceiving the global navigation satellite.

The global navigation satellite receiver may output measurement data associated with a pseudo range and a carrier phase between a navigation satellite and the global navigation satellite receiver, a navigation message including data associated with a satellite orbit or a satellite clock error correction parameter received from the navigation satellite, or a signal intensity of the global navigation satellite signal.

The apparatus 100 for detecting the deception signal may identify, as the output data, at least one item of information about the measurement data, the navigation message, the navigation solution data, and the signal intensity of the global navigation satellite signal.

In operation 320, the apparatus 100 for detecting the deception signal may determine whether the global navigation satellite signal is a deception signal or a normal signal based on the output data.

As an example, the apparatus 100 for detecting the deception signal may verify whether a position coordinate of a fixed point at which the global navigation satellite receiver is disposed is identical to a position coordinate within the navigation solution data generated by the global navigation satellite receiver. The apparatus 100 for detecting the deception signal may determine the global navigation satellite signal to be normal when the difference between the two position coordinates is less than a variable threshold value, and when the difference between the two position coordinates exceeds the variable threshold value, may detect an anomaly with respect to the position coordinate within the navigation solution data caused by a deception signal.

The variable threshold value may be set using a first value for examination generated by a comparison based on a pseudo range and a carrier phase within measurement data or a second value for examination generated by a comparison based on a navigation message.

For example, when an anomaly is detected with respect to the measurement data, the variable threshold value may be set to a predetermined rate, for example, 50%, 100%, and 200%, of the first value for examination, and when an anomaly is detected with respect to the navigation message, the variable threshold value may be set to a predetermined rate of the second value for examination.

Accordingly, the apparatus 100 for detecting the deception signal may easily detect a deception signal causing a relatively small error by variably adjusting a threshold value of a navigation solution examiner based on a plurality of values for examination of a measurement examiner and a message examiner.

As another example, the apparatus for deceiving a global navigation satellite may transmit a higher deception signal than a normal global navigation satellite signal to the global navigation satellite receiver to allow the global navigation satellite receiver to process the deception signal. Accordingly, the apparatus 100 for detecting the deception signal may determine the global navigation satellite signal measured to be higher than the normal signal to be the deception signal.

The apparatus 100 for detecting the deception signal may generate a third value for examination by comparing a signal intensity of the global navigation satellite signal subsequent to a predetermined period of delay time elapsing to a signal intensity of a signal intensity reference value, determine whether the third value for examination exceeds a predetermined value, and determine the global navigation satellite signal to be a deception signal.

The signal intensity reference value may be set to be an average intensity value of a “k” number of signals, “k” being a natural number, output from the global navigation satellite receiver.

The apparatus 100 for detecting the deception signal may measure a current signal intensity of the global navigation satellite signal input to the global navigation satellite receiver to verify a signal intensity change and determine whether the global navigation satellite signal is a deception signal. Also, the apparatus 100 for detecting the deception signal may verify a signal intensity change subsequent to a predetermined period of delay time elapsing, and determine whether the global navigation satellite signal is a deception signal in order to avoid an instance in which a simple signal intensity change is determined to be caused by a deception signal.

The apparatus 100 for detecting the deception signal may enhance an accuracy of detecting a deception signal by comparing signal intensity changes using the delay time.

As still another example, a momentary anomaly is likely to be generated in the output data because the GPS performs positioning using a global navigation satellite signal from a navigation satellite. Accordingly, complex determining as to whether the anomaly is detected simultaneously from the output data is required to be performed to accurately verify a presence of a deception signal.

Accordingly, the apparatus 100 for detecting the deception signal may enhance an accuracy of detecting a deception signal based on the method of complex determining in which the global navigation satellite signal is determined to be the deception signal as an anomaly is detected by at least two of the measurement examiner, the message examiner, and the navigation solution examiner.

For example, with an anomaly being detected by at least two of the measurement examiner, the message examiner, and the navigation solution examiner, when a signal intensity examiner measures an intensity of the global navigation satellite signal to be higher than an intensity of a predetermined normal signal, the signal intensity examiner may determine the global navigation satellite signal to be a deception signal, and otherwise, may determine the global navigation satellite signal to be a normal signal.

According to the present exemplary embodiment, a presence of an anomaly detected in a global navigation satellite receiver may be easily verified by determining whether a global navigation satellite signal input to the global navigation satellite receiver is a deception signal or a normal signal based on the output data output from the global navigation satellite receiver.

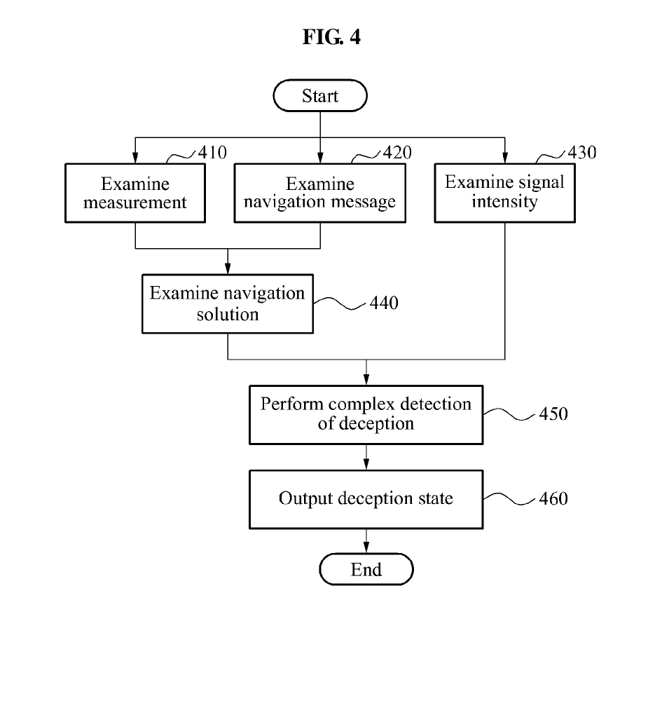

FIG. 4 is a flowchart illustrating a method of detecting a deception signal in a global navigation satellite receiver according to another embodiment of the present invention.

The method of detecting the deception signal in the global navigation satellite receiver may be performed by the apparatus 100 of FIG. 1 for detecting the deception signal.

Referring to FIG. 4, in operation 410, the apparatus 100 for detecting the deception signal may examine a measurement.

For example, the apparatus 100 for detecting the deception signal may generate a difference between a pseudo range and a carrier phase within measurement data and a normal value to be a first value for examination. The measurement examiner 210 may determine the first value for examination to be normal when the first value for examination is less than a predetermined value, and may detect an anomaly with respect to the pseudo range and the carrier phase within the measurement data caused by the deception signal when the first value for examination exceeds the predetermined value.

For example, the normal value may be read from a memory as measurement data in a most recent instance in which the first value for examination is determined to be normal. Alternatively, the normal value may be input by a user.

In operation 420, the apparatus 100 for detecting the deception signal may examine a navigation message.

The apparatus 100 for detecting the deception signal may read a previous navigation message maintained in the memory, and generate a difference between a satellite orbit, or a satellite clock error correction parameter received from the navigation satellite in the navigation message to be a second value for examination. The apparatus 100 for detecting the deception signal may determine the second value for examination to be normal when the second value for examination is less than a predetermined value, and detect an anomaly with respect to the satellite orbit or the satellite clock error correction parameter within the navigation message caused by a deception signal when the second value for examination exceeds the predetermined value.

In operation 430, the apparatus 100 for detecting the deception signal may examine a signal intensity.

To allow the global navigation satellite receiver to process the deception signal, an apparatus for deceiving the global navigation satellite may transmit a deception signal higher than a normal global navigation satellite signal to the global navigation satellite receiver. Accordingly, the apparatus 100 for detecting the deception signal may determine a global navigation satellite signal measured to have a higher intensity than the normal signal to be a deception signal.

The apparatus 100 for detecting the deception signal may measure a current signal intensity of the global navigation satellite signal input to the global navigation satellite receiver to verify a signal intensity change and determine whether the global navigation satellite signal is a deception signal Also, the apparatus 100 for detecting the deception signal may verify a signal intensity change subsequent to a predetermined period of delay time elapsing and determine whether the global navigation satellite signal is a deception signal in order to avoid an instance in which a simple signal intensity change is determined to be caused by a deception signal.

A signal intensity reference value may be set to be an average intensity value of a “k” number of signals, “k” being a natural number, output from the global navigation satellite receiver.

The apparatus 100 for detecting the deception signal may enhance an accuracy of detecting a deception signal by comparing a signal intensity change using the delay time value.

In operation 440, the apparatus 100 for detecting the deception signal may examine a navigation solution.

For example, the apparatus 100 for detecting the deception signal may verify whether a position coordinate of a fixed point at which the global navigation satellite receiver is disposed is identical to a position coordinate within the navigation solution data generated by the global navigation satellite receiver. The apparatus 100 for detecting the deception signal may determine the global navigation satellite signal to be normal when a difference between the two position coordinates is less than a variable threshold value, and detect an anomaly with respect to the position coordinate within the navigation solution data caused by the deception signal when the difference between the two position coordinates exceeds the variable threshold value.

The variable threshold value may be set using the first value for examination generated by a comparison based on a pseudo range and a carrier phase within measurement data, or the second value for examination generated by a comparison based on a navigation message.

For example, when an anomaly is detected with respect to the measurement data, the variable threshold value may be set to a predetermined rate, for example, 50%, 100%, and 200%, of the first value for examination, and when an anomaly is detected with respect to the navigation message, the variable threshold value may be set to a predetermined rate of the second value for examination.

Accordingly, the apparatus 100 for detecting the deception signal may easily detect a deception signal causing a relatively small error by variably adjusting a threshold value of a navigation solution examiner based on a plurality of values for examination of a measurement examiner and a message examiner.

In operation 450, the apparatus 100 for detecting the deception signal may perform a complex deception detection.

The apparatus 100 for detecting the deception signal may determine a deception signal by integrating a plurality of examination results when the plurality of examinations is completed.

For example, with an anomaly being detected by at least two of the measurement examiner, the message examiner, and the navigation solution examiner, when an intensity of the global navigation satellite signal is measured to be higher than an intensity of a predetermined normal signal, the apparatus 100 for detecting the deception signal may determine the global navigation satellite signal to be a deception signal, and otherwise, may determine the global navigation satellite signal to be a normal signal.

In operation 460, the apparatus 100 for detecting the deception signal may output a deception state.

The apparatus 100 for detecting the deception signal may indicate the global navigation satellite signal to be a deception signal when the global navigation satellite signal is determined to be the deception signal. The apparatus 100 for detecting the deception signal may provide a user with information about a presence of a deception signal detected, and thus, readily provide information on an authenticity of a global navigation satellite service.

According to the present exemplary embodiment, a presence of an anomaly detected in a global navigation satellite service may be easily verified by determining whether a global navigation satellite signal input to the global navigation satellite receiver is a deception signal or a normal signal based on the output data output from the global navigation satellite receiver.

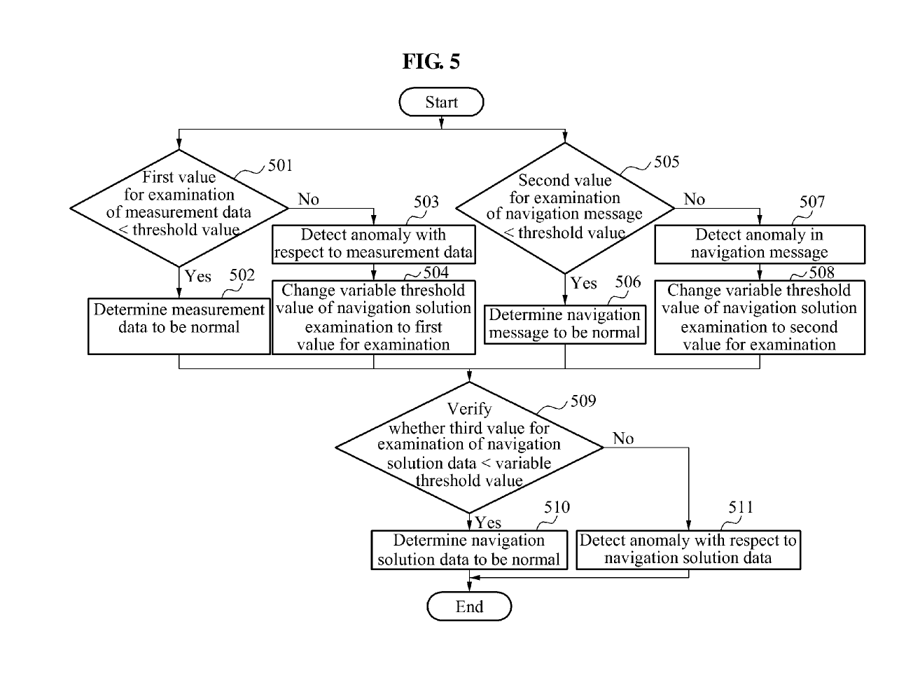

FIG. 5 is a flowchart illustrating an operation process of an examiner according to an embodiment of the present invention.

Referring to FIG. 5, in operation 501, the apparatus 100 of FIG. 1 for detecting the deception signal may verify whether a first value for examination with respect to measurement data is less than a threshold value.

The apparatus 100 for detecting the deception signal may verify whether the first value for examination, generated by comparing a pseudo range and a carrier phase within the measurement data to a normal value, is less than a predetermined value.

In operation 502, the apparatus 100 for detecting the deception signal may determine the measurement data to be normal when the first value for examination is determined to be less than the threshold value as a result of the verifying in operation 501.

In operations 503 and 504, the apparatus 100 for detecting the deception signal may detect an anomaly with respect to the measurement data, and change a variable threshold value of a navigation solution examination to be set as the first value for examination when the first value for examination exceeds the threshold value as a result of the verifying in operation 501.

In operation 505, the apparatus 100 for detecting the deception signal may verify whether a second value for examination of a navigation message is less than the threshold value.

The apparatus 100 for detecting the deception signal may verify whether the second value for examination, generated by comparing the navigation message to a previous navigation message, is less than a predetermined value.

In operation 506, the apparatus 100 for detecting the deception signal may determine the navigation message to be normal when the second value for examination is determined to be less than a threshold value as a result of the verifying in operation 505.

In operations 507 and 508, the apparatus 100 for detecting the deception signal may detect an anomaly with respect to the navigation message, and change the variable threshold value of the navigation solution examination to be set to be the second value for examination when the second value for examination exceeds the threshold value as the result of the verifying in operation 505.

In operation 509, the apparatus 100 for detecting the deception signal may verify whether a third value for examination of navigation solution data is less than a variable threshold value.

The apparatus 100 for detecting the deception signal may verify whether the third value for examination generated by comparing a signal intensity of the global navigation satellite signal subsequent to a predetermined delay time elapsing to signal intensity of a signal intensity reference value is less than the variable threshold value changed in operation 504 or 508.

In operation 510, the apparatus 100 for detecting the deception signal may determine the navigation solution data to be normal when the third value for examination is less than the variable threshold value as a result of the verifying in operation 509.

In operation 511, the apparatus 100 for detecting the deception signal may detect an anomaly with respect to the navigation solution data when the third value for examination exceeds a variable threshold value as a result of the verifying in operation 509.

According to the present exemplary embodiment, it is possible to readily determine a presence of an anomaly with respect to a global navigation satellite service by determining whether a global navigation satellite signal input to the global navigation satellite receiver is a deception signal or a normal signal based on output data output from the global navigation satellite receiver.

According to the present exemplary embodiment, it is possible to enhance an accuracy of detecting a deception signal based on a complex determination method in which a global navigation satellite signal is determined to be a deception signal, as an anomaly, is detected by at least two of a navigation solution examiner, a measurement examiner, and a message examiner.

According to the present exemplary embodiment, it is possible to enhance an accuracy of detecting a deception signal by variably applying a variable threshold value in a navigation solution examiner based on a value for examination in a measurement examiner or a message examiner.

According to the present exemplary embodiment, it is possible to enhance an accuracy of detecting a deception signal by comparing, by a signal intensity examiner, signal intensity changes using a value of delay time.

According to the present exemplary embodiment, it is possible to reduce costs of implementing an apparatus for detecting a deception signal, and prevent damage inflicted on several application services of a GPS by determining a presence of deception with respect to a global navigation satellite signal based on output data of a global navigation satellite receiver.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for detecting a deception signal in a global navigation satellite receiver, the apparatus comprising:
an identifier configured to identify data output from a global navigation satellite receiver receiving an input of a global navigation satellite signal; and
a determiner configured to determine whether the global navigation satellite signal is a deception signal or a normal signal based on the output data.

2. The apparatus of claim 1, wherein when navigation solution data associated with a position and a time of the global navigation satellite receiver is identified to be the output data,
the determiner is configured to detect an anomaly with respect to the navigation solution data, and determine the global navigation satellite signal to be a deception signal when a distance between a position of a fixed point at which the global navigation satellite receiver is disposed and a position of the global navigation satellite receiver within the navigation solution data exceeds a variable threshold value.

3. The apparatus of claim 2, wherein the variable threshold value is set using a first value for examination generated by a comparison based on a pseudo range and a carrier phase within measurement data, or a second inspection value generated by a comparison based on a navigation message.

4. The apparatus of claim 1, wherein when measurement data associated with a pseudo range between a navigation satellite and the global navigation satellite receiver and a carrier phase is identified to be the output data,
the determiner is configured to generate a first value for examination by comparing the pseudo range and the carrier phase within the measurement data to a normal value, and when the first value for examination exceeds a predetermined value, detect an anomaly with respect to the measurement data, and determine the global navigation satellite signal to be a deception signal.

5. The apparatus of claim 1, wherein when a navigation message including data associated with a satellite orbit or a satellite clock error correction parameter received from the navigation satellite is identified to be the output data,
the determiner is configured to generate a second value for examination by comparing the navigation message to a previous navigation message, and when the second value for examination exceeds a predetermined value, detect an anomaly with respect to the navigation message, and determine the global navigation satellite signal to be a deception signal.

6. The apparatus of claim 1, wherein when a signal intensity of the global navigation satellite signal is identified to be the output data,
the determiner is configured to generate a third value for examination by comparing the signal intensity of the global navigation satellite signal subsequent to a predetermined period of delay time elapsing to a signal intensity reference value, determine whether the third value for examination exceeds a predetermined value, and determine the global navigation satellite signal to be a deception signal.

7. The apparatus of claim 6, wherein the signal intensity reference value is set to be an average intensity value of a “k” number of signals, “k” being a natural number, output from the global navigation satellite receiver.

8. The apparatus of claim 1, wherein the determiner is configured to determine the global navigation satellite signal to be a deception signal as at least two examiners detect an anomaly from among a navigation solution examiner, a measurement examiner, and a message examiner.

9. The apparatus of claim 1, further comprising:
a provider configured to indicate the global navigation satellite signal is a deception signal when the global navigation satellite signal is determined to be a deception signal.

10. The apparatus of claim 1, further comprising:
a memory configured to maintain a result of the determining by the determiner by associating the result with the output data.

11. A method of detecting a deception signal in a global navigation satellite receiver, the method comprising:
identifying data output from a global navigation satellite receiver receiving an input of a global navigation satellite signal; and
determining whether the global navigation satellite signal is a deception signal or a normal signal using the output data.

12. The method of claim 11, wherein when navigation solution data associated with a position and a time of the global navigation satellite receiver is identified to be the output data,
the determining of whether the global navigation satellite signal is the deception signal or the normal signal comprises:
detecting an anomaly with respect to the navigation solution data, and determining the global navigation satellite signal to be a deception signal when a distance between a position of a fixed point at which the global navigation satellite receiver is disposed and a position of the global navigation satellite receiver within the navigation solution data exceeds a variable threshold value.

13. The method of claim 12, wherein the variable threshold value is set using a first value for examination generated by a comparison based on a pseudo range and a carrier phase within measurement data, or a second value for examination value generated by a comparison based on a navigation message.

14. The method of claim 11, wherein when measurement data associated with a pseudo range between a navigation satellite and the global navigation satellite receiver and a carrier phase is identified to be the output data,
the determining of whether the global navigation satellite signal is the deception signal or the normal signal comprises:
generating a first value for examination by comparing a pseudo range and a carrier phase within the measurement data to a normal value, and when the first value for examination exceeds a predetermined value, detecting an anomaly with respect to the measurement data, and determining the global navigation satellite signal to be a deception signal.

15. The method of claim 11, wherein when a navigation message including data associated with a satellite orbit or a satellite clock error correction parameter received from the navigation satellite is identified to be the output data,
the determining of whether the global navigation satellite signal is the deception signal or the normal signal comprises:
generating a second value for examination by comparing the navigation message to a previous navigation message, and when the second value for examination exceeds a predetermined value, detecting an anomaly with respect to the navigation message, and determining the global navigation satellite signal to be a deception signal.

16. The method of claim 11, wherein when signal intensity of the global navigation satellite signal is identified to be the output data,
the determining of whether the global navigation satellite signal is the deception signal or the normal signal comprises:
generating a third value for examination by comparing signal intensity of the global navigation satellite signal subsequent to a predetermined period of delay time elapsing to a signal intensity reference value, determining whether the third value for examination exceeds a predetermined value, and determining the global navigation satellite signal to be a deception signal.

17. The method of claim 16, wherein the signal intensity reference value is set to be an average intensity value of a “k” number of signals, “k” being a natural number, output from the global navigation satellite receiver.

18. The method of claim 11, wherein the determining of whether the global navigation satellite signal is the deception signal or the normal signal comprises:
determining the global navigation satellite signal to be a deception signal as at least two examiners detect an anomaly from among a navigation solution examiner, a measurement examiner, and a message examiner.

19. The method of claim 11, further comprising:
indicating that the global navigation satellite signal is a deception signal when the global navigation satellite signal is determined to be a deception signal.

20. The method of claim 11, further comprising:
maintaining a result of the determining by associating the result with the output data.
